(19) United States
(12) Patent Application Publication
(10) Pub. No.: US 2007/0232285 A1
(43) Pub. Date: Oct. 4, 2007

(54) Call answering system and methods

(76) Inventors: Steven Lush, Cupertino, CA (US); Bradley T. Kenyon, Cupertino, CA (US); Richard A. Gerbeling, Cupertino, CA (US); Jeffrey M. Cameron, Cupertino, CA (US); Robert G. Miller, Cupertino, CA (US); Srinivas Chilukuri, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/390,595

(22) Filed: Mar. 28, 2006

(51) Int. Cl. H04M 3/00

(52) U.S. Cl. 455/418; 455/426.1

(57) ABSTRACT

A call answering system and methods for use on a mobile network is provided. In an illustrative implementation, a call answering system operable on the mobile network comprises a call answering engine and one or more instruction sets to instruct the call answering engine to process calls on the mobile network according to a selected call paradigm. In an illustrative operation, the call answering engine allows mobile phones to be categorized in an answering group such that if a call is made to one of the mobile phones of the answering group, all of the mobile phones of the answering group are notified and are allowed to answer and/or join the call.

Mobile telephony is increasingly becoming a preferred mode of communication. With the advancement of mobile telecommunications technologies, various features and operations that once were thought impractical and infeasible to deploy in a mobile telecommunications infrastructure are becoming common place. For example, with current mobile telecommunications technologies, mobile device subscribers can incorporate various telephony processing services on their mobile telephones. Such services include call forwarding, call waiting, three-way calling, short message services (e.g., text messaging), digital content streaming (e.g., broadcasting of television content to a mobile telephone/mobile smart-phone), and customized ring tones.

With current mobile telecommunication technologies, a mobile device (e.g., mobile telephone or other mobile device) is in communication with a mobile telephony/data network that serves to pass voice/data originating from a mobile device or other cooperating telecommunications network to another mobile device or other cooperating telecommunications network. The mobile telephony/data network can maintain one or more computing environments that support one or more computing applications operable to provide the various telephony processing services. In current deployments, the mobile/telephony data network can be designed to have a certain degree of robustness so that additional services/features can be easily deployed across the network and used on the mobile telephony handsets. This robustness can be provided by the type of mobile telephony protocol chosen.

For example, mobile networks operating on digital communication protocols such as the global standard mobile (GSM) or the general packet radio service (GPRS) mobile data/voice communication protocol are afforded certain latitude in the type of services that can be deployed on such mobile networks. The flexibility can be result from the various features of the communications protocol including compression techniques employed, encoding techniques employed, decoding techniques employed, power consumption requirements, etc. In many of today's mobile networks, short message service, multi-party calling, call forwarding, voice-mail, and web browsing can be provided to participating users (e.g., users having cooperating mobile handsets operable on such mobile networks).

However, with the advances in mobile network technology, currently there does not exist a call answering system and/or methods operable on a mobile network to allow for multiple handsets answer a single incident call. The analog in conventional telephony is the ability to originate a call to a destination point and have multiple extensions at the destination point ring for the incident call. In conventional telephony, such call answering paradigm allows multiple participating users to join in on a single call from a single destination point. With current practices and applications, mobile networks are operable to have a single handset answer an incident call.

From the foregoing it is appreciated that there exists a need for system and methods that overcome the shortcomings of the prior art.

### BRIEF DESCRIPTION OF THE DRAWINGS

The call answering systems and methods for use in mobile networks are further described with reference to the accompanying drawings in which:

FIG. 1 is a block diagram of an exemplary mobile network environment in accordance with an illustrative implementation of the herein described systems and methods;

FIG. 2 is a block diagram showing the cooperation of exemplary components of an exemplary mobile network environment, in accordance with an embodiment;

FIG. 3 is a block diagram showing the deployment of exemplary components of an exemplary mobile network environment, in accordance with an embodiment;

FIG. 4 is a is a flow diagram showing the processing performed when configuring call answering on an exemplary mobile network environment, in accordance with an embodiment; and

FIG. 5 is a flow diagram showing the processing performed when performing call answering on an exemplary mobile network, in accordance with an embodiment.

### DETAILED DESCRIPTION

Overview:

When receiving a call on a wire-line phone, the person answering the phone (e.g., “Answerer”) has an opportunity to see who the calling party is through a Caller Identification (Caller ID) feature. The Answerer can then choose to answer or notify another person at the location that the call is for them and let them answer. Such ability can be of particular value to a household having household members consistently receiving the bulk of the calls (e.g., teenage children).

The herein described systems and methods ameliorate the shortcomings of existing practices by providing a call answering operation on mobile networks that allow for at least two participating users (e.g., operating different cooperating mobile handsets) the ability to answer a single incident call. In an illustrative implementation, a mobile network call answering system comprises a call answering engine operable on the mobile network and cooperating mobile handsets having at least one instruction set to instruct the call answering engine to answer calls according to a selected call paradigm.

In an illustrative operation, the system can operate to ring multiple mobile phones (e.g., each having separate phone numbers). In the illustrative operations, mobile phones can be categorized in an answering group such that the mobile phones in the answering group can ring when a call is made to one of the mobile phones of the answering group and each one of the mobile phones of the answering group can become the Answerer. After the Answerer answers the phone, other mobile phones in the answering group could subsequently join the call if the call is still active. In the illustrative implementation, the mobile phone of the answering group could operate to initiate a separate call while acting as part of the answering group in answering an ongoing call (i.e., in the illustrative implementation, a given mobile phone of an answering group does not have to wait until a call that is directed to a member of the answering group of which the given mobile phone belongs before the given mobile phone can initiate its own call).

Illustrative Mobile Network Environment

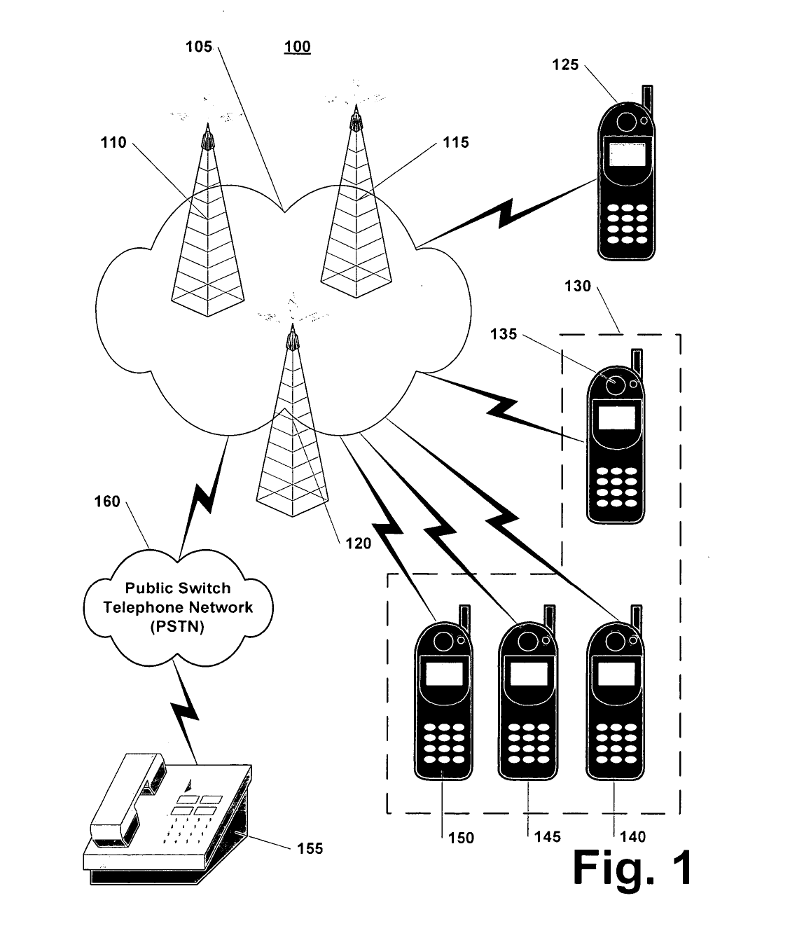

FIG. 1 depicts an exemplary mobile network environment, in accordance with an embodiment. As is shown in FIG. 1, exemplary mobile network environment 100 comprises mobile telephone handsets 125, 135, 140, and 150. Further, as is shown, mobile network environment 100 comprises mobile network 105 that itself can comprises one or more mobile network communications towers 110, 115, and 120, respectively. Mobile network 105 can be operable to communicate to one or more land-wire telephones 155 through cooperating with one or more public switch telephone network (e.g., land-wire telephone network) 160.

In an illustrative operation, any one of mobile telephones 125, 135, 140, 145, or 150 can originate a call on cooperating mobile network 105 for termination among one or more of mobile telephones 125, 135, 140, 145, or 150 and/or land-wire telephones 155 (i.e., through a cooperation between mobile network 105 and PSTN 160). In the illustrative implementation, any one of mobile telephones 125, 135, 140, 145, or 150 can be configured to cooperate with a call answering engine (not shown) that allows for a call processed by mobile network 105 to originate from one of the mobile telephones 125, 135, 140, 145, or 150 and terminate on one or more of mobile telephones 125, 135, 140, 145, or 150 and/or land-wire phone 155.

In an illustrative implementation, mobile telephone 135 can be a member of call answer group 130 (i.e., as indicated by the dashed line—call answer group can comprise one or more of mobile telephones 135, 140, 145, and 150) such that an incoming call coming into one or more of call answer group 130 (and as configured by the mobile telephone operators of mobile telephones 135, 140, 145, and 150) terminates at all of the members of call answer group 130 so that any member of call answer group 130 can answer the incoming call and can join the call (either as the answering member or subsequent to the incoming call being answered as a non-answering member of the call answer group). In the illustrative implementation, similar to a home phone line, the call answer group can operate to tie together users (e.g., a family, a small business, call center operators or any community of interest). In the illustrative implementation, as members of the group use their communicators, other members can be offered options for joining activities in real-time.

Further, in the illustrative implementation, call answer group 130 members can operate mobile devices having different technologies and different mobile communications services. In the illustrative implementation, an exemplary call answer group 130 can comprise a family having “Dad”, “Mom”, “Son”, “Daughter”, and “Grandchildren” group members. In this illustrative implementation, “Dad” can have a 3 G/IMS mobile device that shows a menu item “pick up line being used by Daughter to call Boyfriend” when his daughter places a call, whereas “Mom” may be at a PC where a web interface presents a list of calls in progress that she can join and “Grandma” might have a 2 G handset that receives and SMS or USSD message saying “press 1 to join Grand-Daughters call”.

Moreover, in an illustrative implementation, the members of an exemplary call answer group 130 can have hierarchy and attributes such that in an illustrative operation, the members can have different features and operations available to them in a call answer context. For example, Mom and Dad can be provided functions that “Son” and “Daughter” do not. Dad can have the ability to see, disallow and redirect Daughter's call to Boyfriend while she is placing the call. Additionally, Mom may be able to disconnect a “call” (or gaming event) between Brother and his best friend after she joins their session and tells them they need to get chores done.

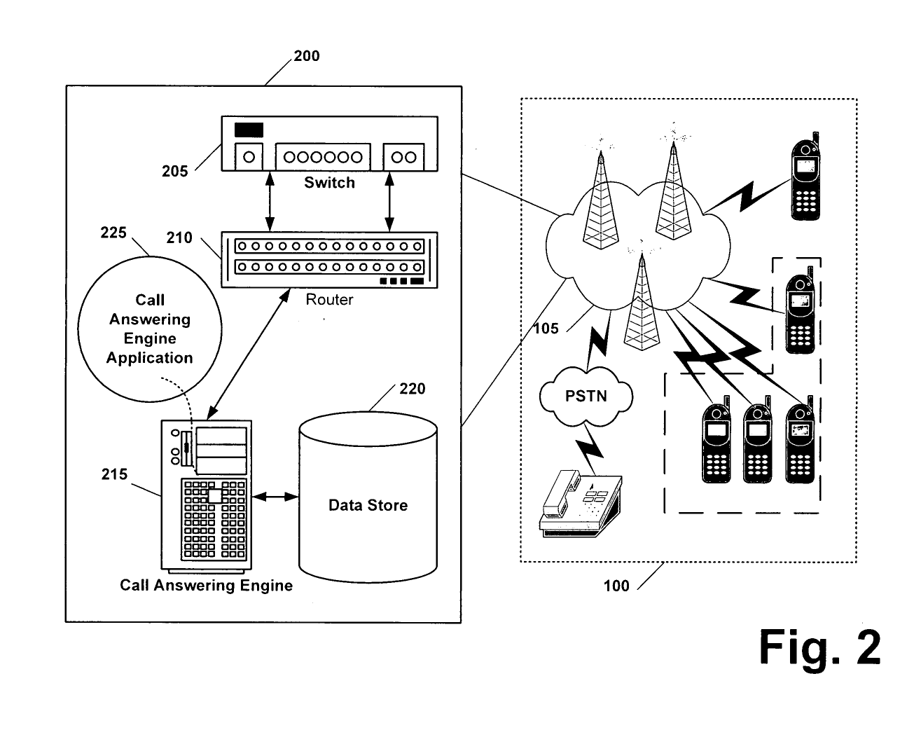

FIG. 2 is a block diagram showing the cooperating components of exemplary mobile network environment 100 of FIG. 1 operating exemplary call answering environment 200, in accordance with an embodiment. As is shown FIG. 2, call answering environment 200 can comprise one or more components of mobile network 105 of mobile network environment 100. Exemplary call answering environment 200 can comprise switch 205 that is in cooperation with router 210 which is in turn in cooperation with call answering engine 215. Further, as is shown, call answering engine 215 can cooperate with data store 220 and can provide the environment to execute and operate call answering engine application.

In an illustrative operation, call answering computing application 225 can comprise one or more instruction sets to instruct call answering engine to answer calls for cooperating mobile telephones of exemplary mobile network 100 according to a selected call paradigm. In the illustrative operation, the selected call answer paradigm can comprise a set of rules that prescribes the manner in which a call is to be answered for a cooperating mobile telephone (e.g., a mobile telephone account). In the illustrative operation, the call answer paradigm can comprises the following rule set:

1) If an incoming call is from telephone number (XXX) XXX-XXXX answer call on mobile telephone and dial all phones of call answer group I so that they can answer and join in on the incoming call;

2) If an incoming call is from area code (XXX) answer call on mobile telephone and dial all phones of call answer group II so that they can answer and join in on the incoming call.

In an illustrative implementation, the call answer paradigm can be customized by an operator (not shown) of the mobile telephone to define and/or modify one or more rules of the call answer paradigm. Further, the exemplary call answer paradigm can comprise rules that allow land-wire telephones (e.g., telephone numbers) to be part of a particular call answer group.

Call Answering:

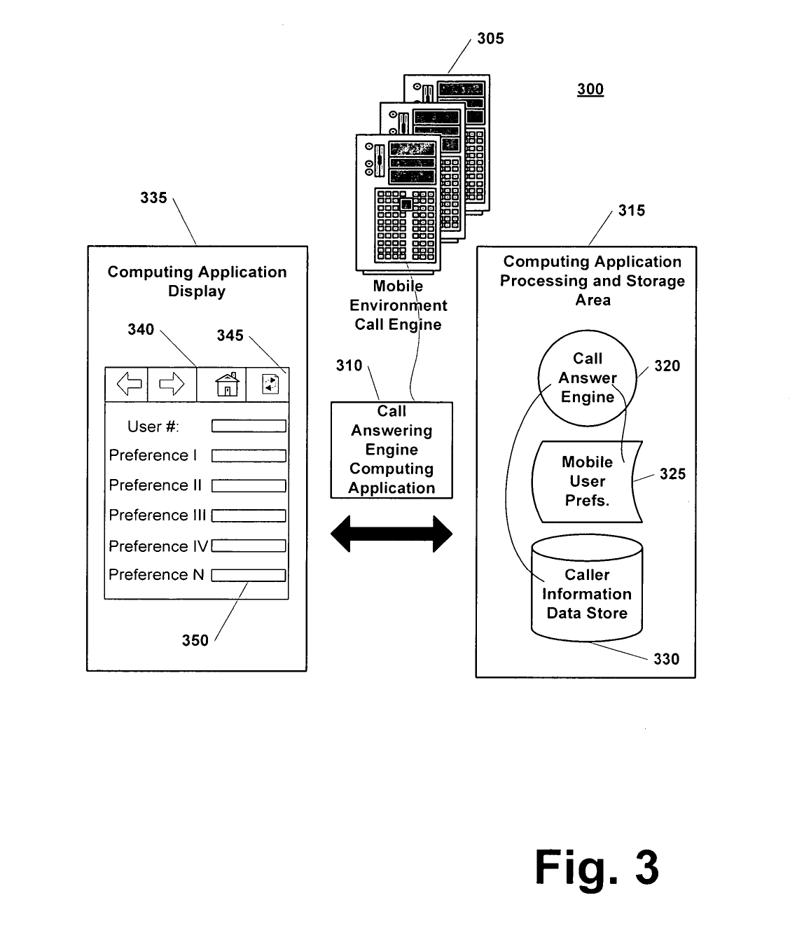

FIG. 3 is a block diagram of an exemplary call answering engine environment operable in mobile network environment 100 of FIG. 1, in accordance with an embodiment. As is shown in FIG. 3, call answering engine environment comprises mobile environment call engine 305 operable to execute call answering engine computing application 310. Further, as is shown, call answering engine computing application 310 comprises computing application display area 335 and computing application processing and storage area 315. In an illustrative implementation, computing application display area 335 can comprise one or more computing browsers 340 for use in inputting and/or displaying data used by call answering engine computing application 310. In the illustrative implementation, exemplary browser 340 can comprise navigation controls 345 and maintain data input dialog/display boxes 350 for use in inputting and/or displaying call answer engine computing application data. Further, in the illustrative implementation, computing application processing and storage area 315 can comprise call engine instruction set 320 that process mobile user preferences 325 and cooperates with call information data store 330.

In an illustrative operation, a participating user (not shown) can cooperate with call answering engine computing application's 310 (e.g., through one or more modalities including but not limited to a mobile handset, a personal digital assistant, a personal computer, etc.) computing application display 335 to input and/or display user preference data providing one or more user preferences in answering calls on exemplary mobile network 100. The inputted data can be processed by call engine instruction set in call answering engine computing application's 310 computing application processing and storage area 315. The preference data input can be processed to generate mobile user preferences 325 that can be stored on call information data store 330. In the illustrative operation mobile environment call engine 305 can operate on exemplary mobile network 100 of FIG. 1 to answer calls for participating users according to mobile user preferences 325.

In the illustrative operation, user preferences can comprise one or more rules of a call answer paradigm that can include but are not limited to rules on answering calls from a particular party, originating from a particular area code, originating from members of a cooperating call answer group, etc. In an illustrative implementation, user preferences can direct mobile environment call engine 305 to answer a call by a call answer group associated with the participating user. In such implementation, the call can be answered and/or joined by any member of the call answer group (e.g., members employing mobile and land-wire telephony devices).

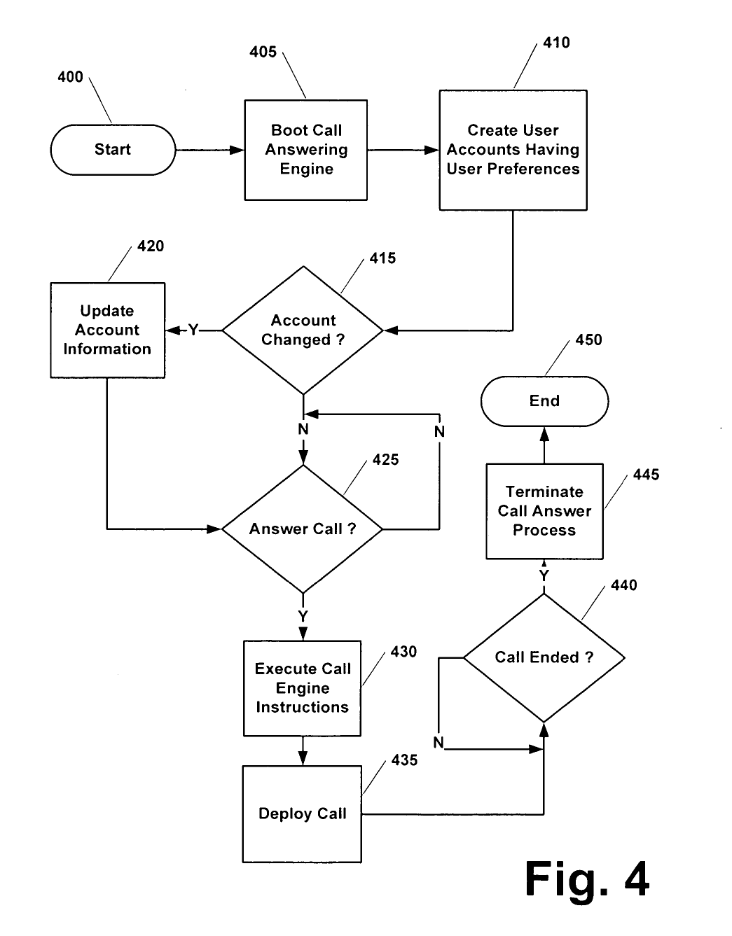

FIG. 4 is a flow diagram showing the processing performed when configuring an exemplary call answering engine operable on an exemplary mobile network environment, in accordance with an embodiment. As is shown, processing begins at block 400 and proceeds to block 405 where the call answering engine is booted to execute one or more call instructions in accordance with a selected call paradigm. From there, processing proceeds to block 410 where user accounts are created to allow participating users to store user preferences. A check is then performed at block 415 to determine if the user account has changed. If the check at block 415 indicates that user account information has changed, processing proceeds to block 420 where the account information is updated. However, if at block 415, it is determined that the user account information has not changed, processing proceeds to block 425 where a check is performed to determine if the call answer function is to be implemented for incoming calls. If the check at block 425 indicates that the call answer function is not to be implemented, processing reverts to the input of block 425.

However, if at block 425, the check indicates that the call answer function is to be implemented for incoming calls, processing proceeds to block 430 where the call engine instructions are executed. A call can then be answered according to the executed call engine instructions at block 435. A check is then performed at block 440 to determine if a call answered by the executed call engine instructions has ended. If the check at block 440 indicates that the call has ended, process proceeds to block 445 where the call answer process for the specific call is terminated. Processing then ends at block 450. However, if at block 440, the check indicates that the call being answered by the executed call instructions of block 430, processing reverts to the input of block 440 and proceeds from there.

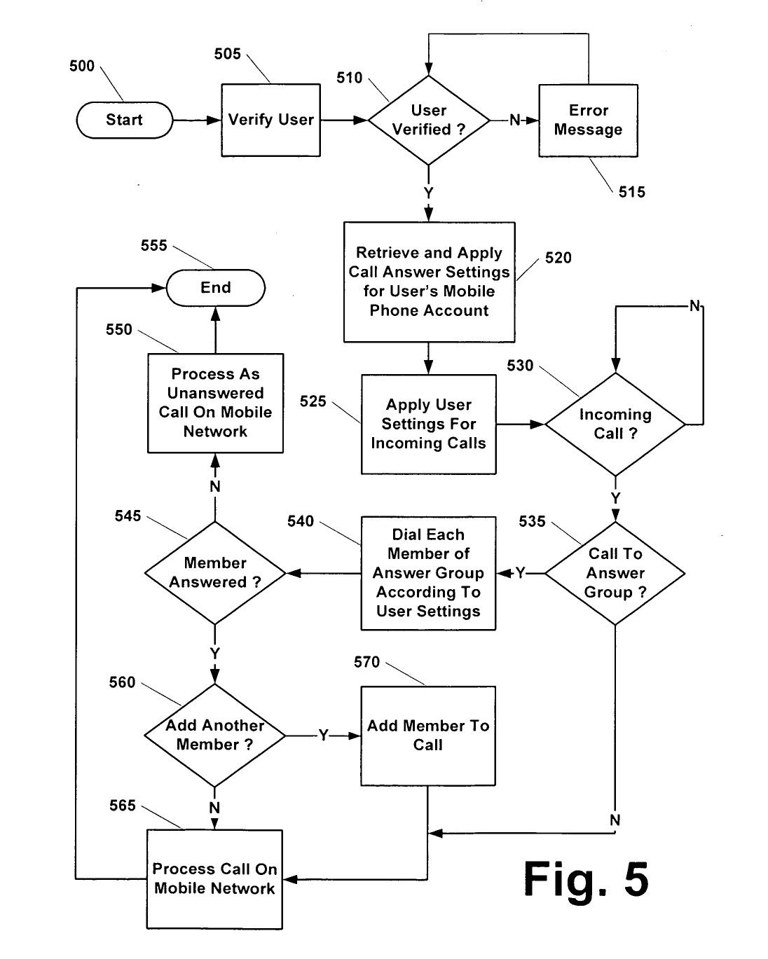

FIG. 5 is a flow diagram showing the processing performed when answering a call according on exemplary mobile network 100 of FIG. 1 operating exemplary call engine 215 of FIG. 2, in accordance with an embodiment. As is shown, processing begins at block 500 and proceeds to block 505 where a participating user of the call answering engine is verified. A check is then performed at block 510 to determine if the user was verified. If the check at block 510 indicates that the user has not been verified, processing proceeds to block 515 where an error is generated to indicate that the user has not been verified to use the call answering engine. From there, processing reverts to the input of block 510 and proceeds from there.

However, if the check at block 510 indicates that the user has been verified, processing proceeds to block 520 where call answer settings are retrieved and applied to the user's mobile phone account. The user settings are then applied for incoming calls at block 525. A check is then performed at block 530 to determine if a participating call answer user is receiving an incoming call. If the check at block 530 indicates that an incoming call is not being received processing proceeds to the input and of block 530 and continues from there. However, if the check at block 530 indicates that an incoming call is being received, processing proceeds to block 535 to determine if the participating user's call answer settings are such to pass the call to a “call answer group”.

If the check at block 535 indicates that the incoming call is not to be answered by a call answer group, processing proceeds to block 565 where the call is processed on the mobile network as a regular call. Processing then terminates at block 555. However, if at block 535, the check indicates that the incoming call is to be answered by a call answer group, processing proceeds to block 540 where each member of the call answer group is called to pass along the incoming call by the call answer engine. A check is then performed at block 545 to determine if at least one member of the call answer group has answered the call. If the check at block 545 indicates that the call was not answered by at least one member of the call answer group, processing proceeds to block 550 where the call is processed as an unanswered call by the mobile network. Processing then terminates at block 555.

However, if at block 545, the check indicates that a member of the call answer group has answered the incoming call, processing proceeds to block 560 where a check is performed to determine if another member of the call answer group is to be added to the answered call (i.e., an incoming call is processed on the exemplary mobile network and if the incoming call is directed to a participating user having call answer settings requiring the call to be able to be answered by any member of a call answer group and at least one member of the call answer group answers the call, the other non-answering members of the call answer group are allowed to join in on the call once the incoming call has been answered). If the check at block 560 indicates that another member is to be added to the answered (e.g., the analog of setting up a teleconference in a land-wire telephone network), processing proceeds to block 570 where the member of the call answer group is added to the answered call such that the added member is allowed to participate on the call as if the non-answering added member answered the incoming call originally. Processing then proceeds to block 565 and proceeds from there. However, if at block 560 the check indicates that another member is not to be added, processing proceeds to block 565 and continues from there.

It is understood that the herein described systems and methods are susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instruction sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A system for call answering on a mobile network, comprising:
a call answering engine operable on a mobile network; and
an instruction set operable to provide at least one instruction to the call answering engine to answer calls according to a selected call answering paradigm,
wherein the call answering paradigm provides for the concurrent answering of a call processed on the mobile network by more than one cooperating mobile telephone device.

2. The system as recited in claim 1 further comprising a call answering computing application executed by the call answering engine and operable to receive data inputs representative of user preferences for call answering.

3. The system as recited in claim 2 wherein the call answering computing application comprises a computing application processing and storage area operable to process and store the data inputs representative of user preferences when answering calls on the mobile network.

4. The system as recited in claim 1 wherein the call answering engine comprises one or more components of the mobile network.

5. The system as recited in claim 1 wherein the call answering engine comprises a computing environment.

6. The system as recited in claim 5 wherein the call answering engine comprises a computing environment having hardware and/or software components.

7. The system as recited in claim 1 further comprising a public switch telephone network.

8. The system as recited in claim 7 wherein the call answering engine is operable to cooperate with land-wire telephones through a public switch telephone network as part of call answering operations.

9. The system as recited in claim 1 further comprising a call answering paradigm operable to prescribe one or more rules to the call answering engine regarding the manner in answering calls in accordance with one or more user preferences.

10. The system as recited in claim 9 wherein the call answering paradigm comprises a rule prescribing to the call answering engine to dial one or more members of a selected call answer group.

11. The system as recited in claim 10 wherein the call answer group comprises at least two members.

12. The system as recited in claim 10 wherein the call answer responsive to processing an incoming call for a participating user according to a selected call paradigm prescribing the answering of a call by a call answer group such that the call answering engine dials the numbers of each member of the call answer group and allows any of the participating members of the call answering group to answer the call and/or join the call.

13. The system as recited in 12 further comprising a plurality of call answer paradigms for each participating user.

14. A method to answer calls comprising:
receiving an indication of an incoming call being processed over a cooperating mobile network by a call answering engine;
processing the indication of the incoming call by the call answering engine according to a selected call answering paradigm to indicate to a cooperating mobile network the manner in which to answer the call so that at least two participating mobile handsets can concurrently answer and/or join in on the incoming call.

15. The method as recited in claim 14 further comprising prescribing by the call answering engine to the mobile network to dial at least two mobile telephone numbers as part of the processing of answering the incoming call, wherein the telephone numbers comprise land-wire and mobile telephone numbers.

16. The method as recited in claim 15 further comprising receiving data representative of one or more user preferences for call answering by the call answering engine.

17. The method as recited in claim 15 further comprising receiving data representative of one or more user preferences for call answering by the call answering engine through a call answering computing application.

18. The method as recited in claim 17 further comprising processing the data representative of user preferences to generate one or more call answering paradigms.

19. The method as recited in claim 17 further comprising executing a computing application on a computing environment in cooperation with a mobile network as part of operating the call answering engine.

20. A computer readable medium having computer readable instructions to instruct a computing environment to perform a method comprising:
receiving an indication of an incoming call being processed over a cooperating mobile network by a call answering engine;
processing the indication of the incoming call by the call answering engine according to a selected call answering paradigm to indicate to a cooperating mobile network the manner in which to answer the call so that at least two participating mobile handsets can concurrently answer and/or join in on the incoming call.

21. A system for answering calls comprising:
a call answering engine operable on a mobile telephone network comprising a computing application for use to process data representative of calls;
a data store comprising user preferences for use by the call answering engine to generate call answering instructions for participating users for use by the mobile network when answering calls such that the mobile network allows for at least two cooperating mobile devices to concurrently answer and/or join an incoming call.
